(19) United States
(12) Patent Application Publication
(10) Pub. No.: US 2012/0022699 A1
(43) Pub. Date: Jan. 26, 2012

(54) Control System for a Partition System

(75) Inventors: Harald Hoopmann, Westerstede (DE); Stefan Rogge, Westerstede (DE)

(73) Assignee: Dorma GmbH + Co. KG, Ennepetal (DE)

(21) Appl. No.: 13/259,964

(22) PCT Filed: Mar. 3, 2010
(86) PCT No.: PCT/EP2010/001295

§ 371 Date: Sep. 23, 2011

(30) Foreign Application Priority Data
Mar. 24, 2009 (DE) 10 2009 014 130.8

(51) Int. Cl. G05B 15/00

(52) U.S. Cl. 700/275

(57) ABSTRACT

A control system for a partition wall system, which has individually displaceable partition wall elements, which each have a subordinate control unit. The wall elements can be disposed to form a closed partition wall by being displaceable in a guiding rail by a drive motor for displacing the partition wall element. The subordinate control units are equipped with a position data detection unit, which detects the position of the partition wall elements independently from an operating state during interruption of energy supply to the control system.

### CROSS REFERENCE TO RELATED APPLICATIONS

This is a U.S. national stage of application No. PCT/EP2010/001295, filed on 3 Mar. 2010. Priority is claimed on German Application No. 10 2009 014 130.8 filed 24Mar. 2009, the content of which are incorporated here by reference.

### BACKGROUND OF THE INVENTION

1. Field of the Invention

The invention relates to a control system for a partition wall system, which has individually displaceable partition wall elements that each have a subordinate control unit and can be disposed to form a closed partition wall, wherein each partition wall element is displaceable in a guiding rail, and for this purpose, has a drive motor for displacing the partition wall element.

2. Description of Prior Art

It is known from EP 1 085 159 B1 that control systems are utilized for automatically displacing partition wall elements. In this case, a central control unit communicates with subordinate control units. During operation of the partition wall system, data, in particular position data, is transmitted between the subordinate control units and the central control unit. However, it has proven to be disadvantageous in this case, that in the event of failure of power supply to the control system or to the subordinate control units, data exchange between the subordinate control units and the central control unit is interrupted, which may result in undefined states of the partition wall system, in particular if individual partition wall elements are manually displaced during power failure, for example in the event of power outage.

### SUMMARY OF THE INVENTION

Therefore, it is an object of the present invention to develop a control system for a partition wall system of the mentioned species, which allows for a simple structure and a high functional safety.

According to one embodiment of the invention, it is intended that the subordinate control units are equipped with a position detection unit, which detects the position of the partition wall elements independently from an operating state, in particular during interruption of energy supply to the control system.

It is particularly advantageous if the power supply to the drive motors and/or to the subordinate control units is realized via at least one supply track, wherein the supply track is disposed in the area of the guiding rail. In this case, the supply track may be disposed separately at the guiding rail, whereby exchange is easier in the event of a defect. In addition it may be conceivable the supply track carries several usable voltages, such that direct voltage and/or alternating voltage can be simultaneously provided. Also utilizing a three-phase current-supply track is conceivable, in particular via a three-wire or a four-wire track, whereby it is possible to use three-phase current consumers. The guiding rail and/or the supply track may comprise in this case of several individual tracks, which are interconnected by a screw connection and/or a plug-in connection. Thereby, transporting the guiding rails and/or the supply tracks to the final place of installation is made easy and a simple assembly is guaranteed. In addition it is conceivable that the supply track is non-positively affixed to the guiding rail via a plug-in connection and/or a screw connection and/or a bonded connection and/or a welded connection. It is likewise conceivable that the supply track is integral with the guiding rail. Therefore, mounting or inserting additional lines for supplying electrical energy to the consumers in or at the partition wall elements is not required, whereby the overall structure is simplified. Nevertheless, it is conceivable that an additional cable duct is provided at or in the guiding rail, in which signal lines and/or electrical energy lines can be run to the individual partition wall elements. This allows for affixing additional electrical consumers having power consumptions above the maximum total power output of the supply track.

A bidirectional data exchange is realized between the central control unit and the subordinate control units of the partition wall elements. The central control unit is thus enabled to query the subordinate control units. Unlike with a unidirectional connection, in this case, the parameters, respectively operating states of the subordinate control units can be transmitted to the central control unit. A pull-method is likewise conceivable in which the subordinate control units automatically request relevant data from the central control unit. Detectable malfunction of the subordinate control units may likewise be transmitted directly to the central control unit such that the central control unit is informed at any time about the overall condition of the individual units of the partition wall system and is thus able to control them in a reliable manner.

As an option, the data exchange between the subordinate control units and the central control unit is realized via a data channel, which is configured as a data line and/or via modulated data on the supply track and/or a radio communication link. When transmitting the data via a data line, a higher level of interference immunity can be achieved by utilizing screened lines. In order to achieve a simple overall structure for the partition wall system, modulated data on the supply track can be utilized, which likewise allow for a bidirectional data exchange. Bidirectional data exchange may be realized likewise via radio communication links, in particular via Bluetooth/GSM/wireless LAN/IrDA/NFC/UMTS/ZigBee/WiMAX/ULP or ultra-sound. In this case, utilizing a combination of all transmission types is likewise feasible.

It is advantageous in a first basic variant of the invention, if the position data detection units and/or the subordinate control units include at least one energy accumulator, in particular a rechargeable energy accumulator, in particular an accumulator of the type Pb, NiCd—, NiH2-, NiMH-, Li-Ion-, LiPo—, LiFe—, Li—Mn—, LiFePO₄—, LiTi—, RAM-, PTMA-, Ni—Fe—, Na/NiCl—, SCiB—, Silver-Zinc-, Vanadium-Redox- or Zinc-Bromine. It is likewise conceivable to employ a capacitor, in particular a double layer capacitor. The particular advantage of these energy accumulators is that, even in the event of an interrupted power supply, the transmission of the position data by the position data detection units will perfectly function via the supply tracks and/or the supply lines, because data, possibly transiently stored in the central control unit and/or the subordinate control units, is not erased. In addition, it is not required to initialize the position data detection units after restoring the power supply via the supply track and/or the supply line. In this variant, a slip-free mechanical connection between the drive motor, respectively the partition wall element and the guiding rail should be present, unless the position data detection units detect directly, i.e. without any other mechanical means, a relative position change of the partition wall element in relation to the guiding rail.

It is likewise conceivable that the partition wall elements are manually displaceable along the guiding rails. It is thereby guaranteed that should the drive motors fail, for example on account of a power outage, the individual partition wall elements can nevertheless be disposed manually to form a closed partition wall. Also, should the control system fail, the user of the partition wall systems is able to manually dispose the individual partition wall elements to form a closed partition wall.

It may be likewise provided that the position data detection units and/or the subordinate control units have sensors, in particular position sensors. The position sensors may transmit position data to the subordinate control units, which in turn transmit said data to the central control unit for the purpose of monitoring the whole partition wall system. In this case, it is conceivable to initially store the position data in chronological order in the individual subordinate control units, in order to forward them, if required and necessary, to the central control unit. It is thereby possible to efficiently avoid redundant data exchange between the subordinate control units and the central control unit. Moreover, it is conceivable the subordinate control units have abutment sensors and/or proximity sensors, which are able to avoid a collision between the individual partition wall elements. It is likewise conceivable that the data of the abutment sensors and/or proximity sensors are autonomously processed by the subordinate control units in order to directly control the drive motors. It is thereby possible to avoid collision between the partition wall elements should the central control unit fail. It is furthermore conceivable that sensors for pressure, light, position, oscillation and/or humidity are affixed in addition to the subordinate control units. It is thereby possible to allow the individual partition wall elements to detect outside influences, such as impacts, direct insolation and/or contact with water, in order to initiate targeted corrective measures, for example automatically displacing the partition wall elements.

Furthermore, in a second basic variant of the invention, it is conceivable that the guiding rail has a position code and therefore it is possible to determine an absolute position of the individual partition wall elements. In this case, it is conceivable the position code is realized by an electrical resistance path, which is affixed to the guiding rail. In this case, a sliding contact, which can be affixed to the subordinate control units, measures the actual resistance value, which, depending on the traveling direction of the partition wall elements, increases or decreases. This is why the actual position of the individual partition wall elements can be absolutely determined at any time, such that an energy accumulator for detecting a relative change in position, like in the first variant, can be foregone. In this variant, slippage between the mechanical connection of the drive motor, respectively the partition wall element to the guiding rail may be likewise present, because the respective position of the partition wall element is absolutely detected. It is likewise conceivable that readable codes, in particular optical codes, in the shape of bar codes, are provided at the guiding rail. The codes may be read via an optical measuring sensor, which can be affixed to the subordinate control units. It is thus again possible to efficiently allow to absolutely determine the position of the individual partition wall elements. In this case, utilizing other position code methods in combination with resistance paths and/or bar codes is conceivable. Also a combination of the first variant and the second basic variant of the invention is conceivable, wherein for example a relative position detection can be realized by a step counter, which is affixed to the subordinate control unit, for example at a drive wheel of a carriage which is inserted into the guiding rail, which step counter, when displacing a partition wall element, forwards the impulses or signals to the subordinate unit.

It is likewise conceivable that the subordinate control units have at least one unique identification code, which, in terms of control, unambiguously characterizes the partition wall elements. It is thereby possible for the central control unit to address, respectively to control the individual subordinate control units independently from each other. This is why the individual partition wall elements can be displaced within the guiding rail independently from each other. Unlike a wire solution for controlling the individual partition wall elements, the complexity of the control system structure is independent from the number of partition wall elements, because no additional wiring is required. Moreover, it is conceivable that several available compound parking boxes are provided for the partition wall elements in a simple way and manner within the overall system, in which the partition wall elements are positioned when not in use.

It may be likewise provided that the partition wall elements have additional actuators, which are addressable by the subordinate control units via a unique additional identification code. In this case, it is conceivable that the individual partition wall elements have actuators, such as heating elements, lighting elements, ventilators, display elements, speakers or sun visor elements. Moreover, it is possible to realize the data exchange in packet-mode between the central control unit and the subordinate control units. It is thereby likewise possible to simultaneously execute several functions of the actuators by the subordinate control units.

Furthermore, it is an object of the invention to provide a method of the type mentioned in the introduction, which increases the functional safety of a generic partition wall system, in particular in the event of electrical malfunctioning. According to one embodiment of the invention, this problem is solved in that, if the power supply is interrupted, the subordinate control units transmit the respective position data to the central control unit via the position data detection units, once the power supply is restored.

One embodiment of the inventive method features the advantages already explained in conjunction with the inventive device.

Advantageously, when manually displacing the partition walls during a power interruption, the position data is continuously metrologically detectable, because the position data detection units have an energy accumulator, in particular a rechargeable energy accumulator (variant I). It is thereby possible to employ systems that metrologically detect the relative position of the individual partition wall elements, such as done for example by incremental encoders (rotary encoders) affixed to a carriage. Moreover, it is likewise possible to metrologically detect the absolute position of the partition wall elements by a position code on the guiding rail, for example by an optical sensor affixed to the carriage (variant II). On account of these possibilities for detecting the position, likewise by combining the two variants I and II essential to the invention, the partition wall elements can be reliably prevented from colliding, when the central control unit and/or the power supply of the supply tracks is switched on again, because the actual position data of the partition wall elements are transmitted to the central control unit once the power supply is restored, and the central control unit can therefore perform a collision-free displacement of the partition wall elements. As a consequence, the functional safety of the overall installation is considerably improved by the inventive method.

Further advantages, features and details of the invention will result from the following description, in which several embodiments of the invention are described in detail, reference being made to the drawings. In this context, the features mentioned in the claims and in the description, may be individually or randomly combined essential to the invention.

### BRIEF DESCRIPTION OF THE DRAWINGS

In the drawings:

FIG. 1 is a block diagram of an inventive control;

FIG. 2 is a diagrammatic view of the inventive partition wall system according to one embodiment of the invention,

FIG. 3 is a diagrammatic frontal view of a guiding rail with a drive motor inserted therein, and

FIG. 4 is a simple diagrammatic lateral view of a carriage with a partition wall element affixed thereto.

### DETAILED DESCRIPTION OF THE PREFERRED EMBODIMENTS

FIG. 1 represents a control system 1 with a central control unit 10 and subordinate control units 11 for the respective partition wall elements 21, which communicate with each other via diagrammatically illustrated data channels 12, which comprise physically wire-less and/or electrical conductive connections. In this case, data is sent from the central control unit to the individual subordinate control units 11 via the already mentioned transmission techniques. The subordinate control units 11 as well can send data to the central control unit 10, such as to allow for a reliable data communication in that the subordinate control units 11 acknowledge data receipt to the central control unit 10 and vice versa.

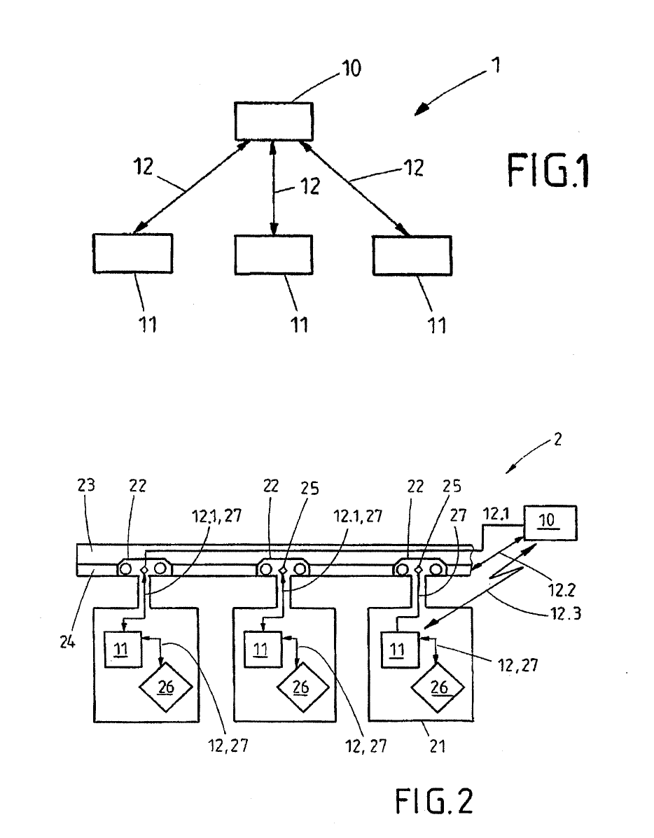

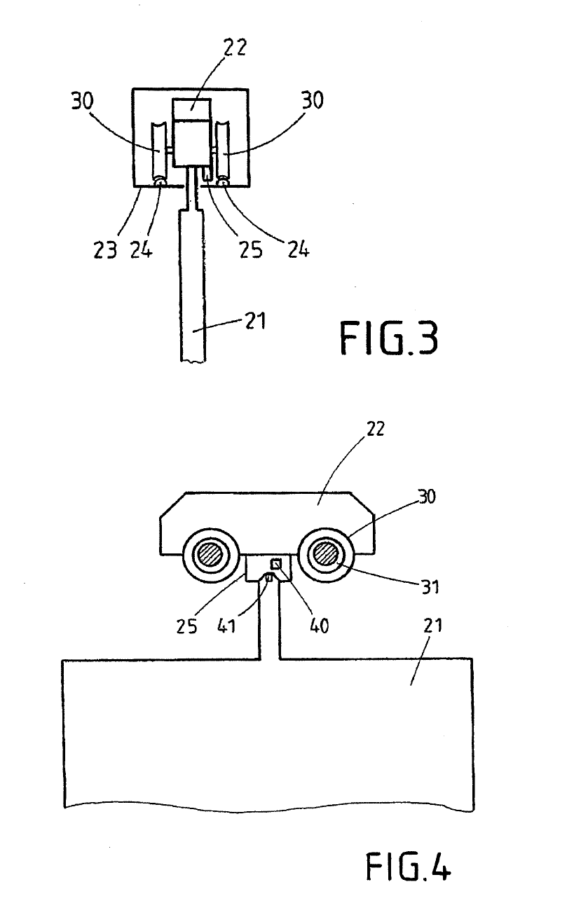

FIG. 2 shows a diagrammatic structure of a partition wall system 2, which has a control system 1, as described in FIG. 1. In this case, the individual partition wall elements 21 have subordinate control units 11 and actuators 26, which are disposed in or at the individual partition wall elements 21. The actuators 26 and possibly the drive motor 22 are supplied with power via an electrical connection 27, which electrically connects the subordinate control unit 11 to the actuators 26. In this case, the subordinate control unit 11 is connected to a carriage via an electrical connection 27. Respectively one partition wall element 21 is essentially attached to be suspended from the one or more carriages (two or more). The respective carriages are in turn movably supported in the guiding rail 23. Current collectors, in particular sliding contacts, affixed in or at the carriage, pick off the voltage applied to the supply tracks 24. It is thus possible to supply the actuators 26 with electrical energy via the supply track 24 (FIG. 3). Respectively one data channel 12 is provided to exchange data between the subordinate control units 11 and the actuators 26. Moreover, it should be mentioned that in FIG. 2 various techniques may be utilized for transmitting data between the subordinate control units 11 and the central control unit 10. However, in practice this will normally not happen, in order to guarantee a homogenous system structure and thus to keep cost of the partition wall system low. Just to mention that the option of having differently configured data channels 12 in a control system 1 is available. Accordingly, the partition wall elements 21, as described in FIG. 2, may exchange data between each other via either a data line 12.1, or via modulated data 12.2 on the supply track 24 or via a radio communication link 12.3. The power supply of both the drive motors 22 and the subordinate control units 11 and the actuators 26 is realized via a supply track 24. In FIG. 2, the drive motors 22 are disposed in the guiding rails 23 by the carriages. It is likewise conceivable that the drive motors 22 are disposed in the partition wall elements 21 and have a gear, which is mechanically coupled to the carriages, respectively to the guiding rail 23. Also affixing an additional guiding rail on the floor is conceivable, which would cooperate with a carriage affixed to the lower end of the partition wall elements 21. This carriage may likewise be driven by a drive motor 22 via a gear or the like.

FIG. 3 illustrates a diagrammatic frontal view of the guiding rail 23 in which a drive motor 22 is located within a carriage. The electric conductive drive wheels 30 are respectively located on a supply track 24, which is affixed to the guiding rail 23 in an electrically insulated manner. This is how among others, electrical energy is supplied to the actuators 26 and the drive motors 22. The supply track 24 likewise supplies power to the subordinate control units 11 and to the actuators 26 which are located in the individual partition wall elements 21. Moreover, the carriage, in particular the drive motor 22 has a position data detection unit 25 including a sensor 41 affixed to the drive motor 22, which sensor is able to read a bar code affixed to the guiding rail 23. Information on the absolute length can be read from this bar code, such that the central control unit always knows the exact position of the individual partition wall elements 21, i.e. even after a power failure.

FIG. 4 shows the frontal view of a drive motor 22, to which a partition wall element 21 is affixed. A position data detection unit 25, which is affixed to the drive motor 22, has a sensor 41 and an energy accumulator 40. In this case, the sensor 41 may be an optical measuring sensor, in particular a scanner, which is able to read a bar code affixed to the guiding rail 23 and thus to determine the position of the individual partition wall elements 21. It is likewise conceivable that a sensor would be placed at this location that allows detection of a resistance value by a resistance path affixed to the guiding rail 23. Said resistance value may be transmitted to the central control unit 10 and/or to the subordinate control unit 11 thereby enabled to determine the exact position of the individual partition wall elements 21. Another possibility to detect the position data is to metrologically detect the movement of the individual partition wall elements 21 via a relative movement by a step counter affixed for example to the carriage. For this purpose, for example a rotary encoder may be provided at a motor shaft of the drive motor 22. The detected values are likewise transmitted to the central control unit 10 and/or to the subordinate control unit 11. In this case, the energy accumulators 40, which preferably comprise rechargeable energy accumulators 40, continue to supply power to the position data detection units 25 if the power supply is interrupted, such that the position data is continuously detected, even when manually displacing the partition wall elements 21. Independently from the operating state of the overall system, in both scenarios, the positions of the partition wall elements 21 can be reliably determined, in particular after restoring the energy supply. Moreover, it is conceivable that the power supply of the drive motors 22 is realized via sliding contacts 31, which are located at the drive wheels 30 of the drive motor 22 and positively bear against an energized track affixed to the guiding rail 23. In order to galvanically separate the supply track 24 from the guiding rail 23, prior to installing the supply track 24, an insulating layer may be vapor-deposited on the guiding rail. Moreover, affixing the supply track 24 laterally to the guiding rail 23 is conceivable, such that the supply voltage thereof can be picked off by carbon brushes affixed to the carriages 42.

1.-12. (canceled)

13. A control system for a partition wall system that includes individually displaceable partition wall elements that can be disposed to form a closed partition wall, each partition wall element is displaceable in a guiding rail and has a drive motor for displacing the partition wall element, comprising:
a subordinate control unit for each of the individually displaceable partition wall elements;
a position data detection unit configured to detect a position of each of the individually displaceable partition wall elements independently from an operating state of the control system at least during interruption of a power supply.

14. The control system for a partition wall system according to claim 13, further comprising a power supply for one or more of the drive motor and the subordinate control units is provided by at least one supply track,
wherein the at least one supply track is disposed in an area of the guiding rail.

15. A control system for a partition wall system according to claim 14, further comprising
a central control unit configured for bidirectional data exchange between with the subordinate control units of the individually displaceable partition wall elements.

16. A control system for a partition wall system according to claim 15, wherein
a data channel configured for the data exchange is realized via, configured as one or more of a data line, modulated data on the at least one supply track, and a radio communication link.

17. A control system for a partition wall system according to claim 13, wherein
one or more of the position data detection units and the subordinate control units has an energy accumulator, configured as a rechargeable energy accumulator.

18. A control system for a partition wall system according to claim 13, wherein
the individually displaceable partition wall elements are manually displaceable along the guiding rail.

19. A control system for a partition wall system according to claim 13, wherein
at least one of the position data detection units and the subordinate control units have respective position sensors.

20. A control system for a partition wall system according to claim 13, wherein
the guiding rail has a position code that allows each position of the individually displaceable partition wall elements to be determined.

21. A control system for a partition wall system according to claim 13, wherein
the respective subordinate control units have at least one unique identification code.

22. A control system for a partition wall system according to claim 21, wherein
the individually displaceable partition wall elements have additional actuators, controllable by the subordinate control units via the at least one unique identification code.

23. A partition wall system including a control system comprising:
a subordinate control unit for each of a plurality of individually displaceable partition wall elements;
a position data detection unit configured to detect a position of each of the plural individually displaceable partition wall elements independently from an operating state of the control system at least during interruption of power supply to it.

24. A method for operating a partition wall system, including a plurality of individually displaceable partition wall elements and a control system, which has a central control unit and subordinate control units in each of the plural individually displaceable partition wall elements, comprising:
bidirectionally exchanging position data between each of the subordinate control units, wherein the subordinate control units are equipped with a position data detection unit; and
transmitting by the subordinate control units of the respective position data to the central control unit, via the respective position detection units, in that in an event of failing power supply once the power supply is restored.
